(19) United States
(12) Patent Application Publication
(10) Pub. No.: US 2009/0304933 A1
(43) Pub. Date: Dec. 10, 2009

(54) Method of Painting Carpet and a Carpet Paint Formulation

(76) Inventor: Jeffery Conley, Trabuco Canyon, CA (US)

Correspondence Address: MARC E. HANKIN, ESQ., 11414 THURSTON CIRCLE, LOS ANGELES, CA, 90049, US

(21) Appl. No.: 12/422,931

(22) Filed: Apr. 13, 2009

Related U.S. Application Data
(60) Provisional application No. 61/130,919, filed on Jun. 4, 2008.

(51) Int. Cl. B05D 3/00; B05D 3/12; C09D 133/02

(52) U.S. Cl. 427/299; 427/331; 427/368; 524/556

(57) ABSTRACT

This invention is a carpet paint, and a method for applying the carpet paint to an installed carpet so as to inexpensively achieve a uniform, even distribution of color across the entire surface of the carpet.

### CROSS-REFERENCE TO RELATED APPLICATIONS

This application claims priority to the filing date, Jun. 4, 2008, of U.S. Provisional Patent Application No. 61/130,919, entitled “Carpet Painting System,” to inventor Jeffery R. Conley, all the contents of which are expressly incorporated herein by this reference as though set forth herein in full.

### BACKGROUND OF THE INVENTION

This invention generally relates to carpet paint formulations and methods for applying the carpet paint formulations to carpets as a colored coating. Specifically, it pertains to a specially formulated carpet paint capable of adhering to carpet fibers so as to change the color of the fibers, and a method for painting carpet using the specially formulated carpet paint so that the carpet color may be changed without resorting to installing an expensive new carpet.

Flooring is an important part of interior design. A flooring selection is often the foundation for any design plan. A flooring selection can be one of the largest, and longest lasting, investments a homeowner or businessperson will make regarding a room or an entire facility. Unlike the walls and ceilings of a room, people are in actual physical contact with the floor, so not only must the floor look good, but it must feel good and work on a practical level, coping with traffic, wear, and staining. The choice of a flooring will depend on the room's size, purpose, light sources, what furniture will be selected for the room, color preferences, and style of the room. Usually, the most important factor in selecting a floor type is price. Indeed, when making the decision whether and how to replace an existing floor, the costs involved are an extremely important factor.

Carpets are typically made from tufting and looping yarns through a backing material, such as a jute, to form a pile on one side of the backing. The pile side is the side of the carpet that is face up when installed in a room. The yarns may be dyed before tufting or the entire carpet may be dyed after tufting. Dyeing a carpet requires controlling heat conditions, dyebath immersion, padroll machine application, and/or steaming. Dyeing carpets that have already been cut and installed in a location is possible, but is extremely difficult and frequently unsuccessful. To dye the carpet of an entire room typically results in over or under saturation and, thus, color changes across the area dyed. Furthermore, although small portions of carpets and rugs can be dyed to change their color, the underlying color of the carpet, along with any permanent stains, will continue to have an influence on the overall color of the stained carpet because the underlying color and permanent stains cannot be completely covered up by even the darkest dye colors. Further, dying a carpet to change its color always results in uneven, or even splotchy, color across the entire area of the dyed carpet.

There are several reasons why a dyed carpet, when finished, is unevenly colored. First, the original carpet may have had areas that were shaded differently. This frequently happens in rooms where some areas of the carpet are continually exposed to direct sunlight, and other areas are never exposed to direct sunlight. Additionally, the carpet in one area may be soiled or discolored. As a result, the soiled or discolored areas will dye a different color than on a cleaner portion of the carpet. Finally, dying an installed carpet involves steam cleaning, high temperatures, and, invariably, over saturation of the carpet with the dye, which leads to mold, mildew, and inconsistent coloring throughout the dyed carpet.

Using paint to color a carpet has not been accomplished successfully in the past. In the past, paint on carpet has led to a crunchy, stiff, uncomfortable, and disastrous-looking carpet. That is why it is not attempted by skilled interior designers, or even considered as a viable option by amateur designers. As such, despite the possible solutions that paint may offer, there has never before been disclosed a successful formulation and method for painting carpet. Therefore, there is a long felt need in the art for a specially formulated carpet paint, and method for applying the same, that will comfortably, smoothly, and evenly color carpet and repel stains.

Additionally, most of the methods of applying color to a carpet require that the carpet be brought to the coloring apparatus, rather than having the coloring apparatus color the carpet in the existing carpet location. For example, U.S. Pat. No. 3,419,413, issued to Euforbia; U.S. Pat. No. 4,397,650, issued to Gregoria et al.; and U.S. Pat. No. 2,984,540 issued to Tillett et al., all disclose a method of printing (or dying) fabric or yarn that requires the material to pass through a machine that ensures proper pressure to impart the color onto the material. These methods are completely unsuitable to coloring a carpet that is in a person's home or business. Therefore, there is a need in the art for a method of painting a carpet that is currently installed in a room, house, or other structure.

### BRIEF SUMMARY OF THE INVENTION

To minimize the limitations in the prior art, and to minimize other limitations that will become apparent upon reading and understanding the present specification, the present invention discloses a carpet paint, and a method for applying carpet paint to achieve a uniform color to update an existing installed carpet.

One embodiment of the invention is a carpet paint, comprising: a base paint; an elastomeric acrylic polymer; and a fluorocarbon additive. The base paint is an acrylic paint and is comprised of, a liquid, an acrylic binder, and one or more pigments. The elastomeric acrylic polymer is comprised of, said liquid, an elastomeric acrylic binder. The fluorocarbon additive is a water soluble fluorocarbon additive that improves the ability to clean a painted carpet of oily dirt and provides oil repellence to said painted carpet. The liquid is water and the carpet paint is essentially thirty-two parts said acrylic paint, sixteen parts said elastomeric acrylic polymer, and one part said fluorocarbon additive. The carpet paint is used to coat and color a carpet, wherein the carpet is permanently attached to a floor; and wherein the carpet is colored without removing the carpet from the floor. The carpet paint further comprises one or more of the following components: a sanitizing agent, a fungicide, a biocide, a pesticide, an algaecide, a mildewcide, a boric acid, a pet enzyme, a deodorizer, a florescent, or a scent. The carpet paint further comprises a water-soluble cellulose ether; propylene glycol; a pigment dispersant; a low foam surfactant; an ester alcohol; a foam control agent; a thickening agent; a thixotropic thickening agent; an ammonia; and a non-ionic high shear viscosity builder. The acrylic paint may be a flat paint, a satin paint, a gloss paint, a metallic paint, a multicolored paint, a glow in the dark paint, a florescent paint, a glitter paint, a primer paint, or a multi-tone paint.

Another embodiment of the invention is a method for painting carpet, the steps comprising: providing a carpet; providing a carpet paint, wherein the carpet paint is comprised of a base paint, an elastomeric acrylic polymer, and a fluorocarbon additive; applying the carpet paint to the carpet; wherein the carpet paint is applied in an even manner to said carpet; and applying a fabric softener solution to the painted carpet.

Another embodiment of the invention is a method for painting carpet, the steps comprising: providing a carpet; providing one or more carpet paints; wherein said one or more carpet paints are comprised of a base paint, an elastomeric acrylic polymer, and a fluorocarbon additive; wherein said one or more carpet paints are in a plurality of colors; selecting one or more of said plurality of paint colors to apply to said carpet; pre-mixing said one or more carpet paints; adding at least one of said one or more carpet paints to a paint sprayer; purging said paint sprayer, wherein said paint sprayer is purged until a consistent color and viscosity is achieved; placing a tip of said paint sprayer towards the carpet; spraying said carpet with said paint spray, wherein said spraying begins at a back of said carpet and moves toward a front of said carpet, and wherein said tip of said paint sprayer is moved in a side to side, even, and uniform manner; stopping said spraying step when a first half of said carpet is completed; brushing said one or more carpet paints into said carpet with a carpet brush with a back to front raking motion until said one or more carpet paints evenly coat and color a plurality of fibers of said carpet; continuing said spraying step for a second half of said carpet; and continuing said brushing step for a second half of said carpet. The method for painting a carpet may also include: preparing a fabric softener solution, wherein fabric softener solution is 60% water and 40% fabric softener; applying said fabric softener solution to said painted carpet with a pump sprayer; and brushing said fabric softener solution into said painted carpet with said carpet brush with a back to front raking motion. Typically, the base paint is an acrylic paint and is comprised of, a liquid, an acrylic binder, and one or more pigments; wherein said elastomeric acrylic polymer is comprised of, said liquid, an elastomeric acrylic binder; and wherein said fluorocarbon additive is a water soluble fluorocarbon additive that improves the ability to clean a painted carpet of oily dirt and provides oil repellence to said painted carpet. The carpet is permanently affixed to a floor of a structure, and wherein the carpet is painted when permanently affixed to the floor. The spray tip may be placed between 5 centimeters and 60 centimeters from said carpet, or preferably, the spray tip is placed between 15 centimeters and 25 centimeters from said carpet. The method further comprises: adding one or more scent solutions to said fabric softener solution during said preparing of said fabric softener solution step; cleaning said carpet before painting; inspecting said carpet for stains before painting; identifying stains on said carpet before painting; neutralizing stains on said carpet before painting; preparing an area surrounding said carpet with a protective material; wherein said preparing step prevents said carpet paint from damaging one or more walls and one or more non-carpeted floors in said area surrounding said carpet; wiping off an excess paint from said carpet due to an overspray after painting; removing said protective material from said area surrounding said carpet after painting; cleaning said area surrounding said carpet after painting; and repeating said spraying and brushing steps on one or more additional carpets in one or more additional rooms of the structure.

An object of this invention is to overcome the deficiencies of the prior art.

Another object of this invention is to provide a carpet paint that, when applied to a carpet, will allow the carpet to retain the soft and comfortable characteristics of an unpainted carpet.

Another object of this invention is to provide a convenient, easy to use, affordable, and quick-drying carpet paint.

Another object of this invention is to provide a permanent carpet paint, which is able to withstand liquid spills, abuse, wear and tear, and pets, yet still retain its color.

Another object of this invention is to provide a colored carpet paint that is available in many colors, shades, and types.

Another object of this invention is to provide a carpet painting method that offers flexibility and individuality.

Another object of this invention is to provide a color scheme for painting carpet that allows a user to create a multitude of shades from light to dark hues.

Another object of this invention is to provide a quality paint that will quickly and permanently change the color of a carpet. The carpet paint of the present invention provides durability and the ability to refresh, intensify, or change the color or effect completely.

Another object of the invention is to provide a carpet paint that can be used with the majority of currently available carpets.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings disclose illustrative embodiments. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it is intended to refer to the same or like components or steps.

FIG. 1 is an illustration of a user applying to a carpet the claimed paint formulation using a sprayer.

FIG. 2 is an illustration of a user evenly raking paint into a carpet recently sprayed with paint of the claimed paint formulation.

### DETAILED DESCRIPTIONS OF THE DRAWINGS

In the following detailed description of the preferred embodiment, reference is made to the accompanying drawings that form a part hereof, and in which is shown, by way of illustration, a specific embodiment in which the invention may be practiced. It is to be understood that other embodiments may be utilized and structural changes may be made without departing from the scope of the present invention.

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

The carpet paint formulation of the present invention is preferably composed of, by volume, thirty-two parts base paint, sixteen parts elastomeric acrylic polymer, and one part fluorocarbon additive. However, different formulations may be used without deviating from the scope of this patent. This carpet paint is preferably used to color a carpet, which is preferably permanently attached to the floor. This unique carpet paint formulation and unique method is capable of coloring a carpet without removing the carpet from the floor.

The base paint is preferably an acrylic paint and is composed of a liquid, an acrylic binder, and one or more pigments. The liquid in the paint is preferably water. The elastomeric acrylic polymer is preferably comprised of a liquid, preferably water, and an elastomeric acrylic binder. The fluorocarbon additive is preferably a water soluble fluorocarbon additive that improves the ability to clean a painted carpet of oily dirt and provides oil repellence to said painted carpet.

The carpet paint also preferably contains a water-soluble cellulose ether, a propylene glycol, a pigment dispersant, a low foam surfactant, an ester alcohol, a foam control agent, one or more pigments, a thickening agent, a thixotropic thickening agent, ammonia, wherein the ammonia is preferably 26 degrees Baume, an acrylic binder, and a non-ionic high shear viscosity builder.

The carpet paint also may include a sanitizing agent, such as a fungicide, a biocide, a pesticide, an algaecide, a mildewcide, a boric acid, a pet enzyme, a deodorizer, a florescent, or a scent.

The base paint is preferably an acrylic paint. The acrylic paint may be either a flat paint, a satin paint, a gloss paint, a metallic paint, a multicolored paint, a glow in the dark paint, a florescent paint, a glitter paint, a primer paint, a multi-tone paint, or a combination of any or all of the listed paints.

The carpet paint may contain additional binders, liquids, thickeners, film formers, UV absorbers, UV reflectors, solvents, plasticizers, suspending agents, conditioning agents, colorants, and pearlescents, so long as the additional ingredients do not interfere with the ability of the carpet paint to smoothly, evenly, and permanently coat and color a carpet.

The preferred % by volume range and function of each ingredient of the carpet paint formulation of the present invention is:

| Ingredient | %/Volume | Function |
|---|---|---|
| Water | 25-45% | Dilutant |
| Water-soluble cellulose ether (including, but | <1% | Film Former |
| not limited to, Natrosol ®) | | Thickener |
| | | Stabilizer |
| | | Suspending Agent |
| Propylene glycol | <5% | Control flexibility, hardness, |
| | | freeze/thaw stability, |
| | | suspending agent, and film |
| | | quality |
| Pigment dispersant (including, but not limited | <4% | Pigment dispersant |
| to Tamol ™) | | |
| Low foam surfactant (including, but not | <1% | Film Former |
| limited to Triton ® CF-10) | | |
| Ester alcohol (including but not limited to | <1% | Plasticizer/Coalescent |
| Texanol ®) | | |
| Foam control agent (including, but not limited | <1% | Anti-foam |
| to, Drewplus ® L-475) | | |
| Pigments (including, but not limited to, talc, | 5-20% | Colorant |
| titanium dioxide, iron oxides) | | |
| Pearlescent (including, but not limited to | <4% | Colorant |
| mica) | | |
| Suspending agents (including but not limited | <3% | Thickener/Suspending Agent |
| to Celite) | | |
| Thixotropic thickening agent (including, but | <1% | Thickener |
| not limited to Attagel ®) | | |
| Ammonia | <1% | Solvent |
| Acrylic binder | 18-40% | Emulsion Polymer |
| Elastomeric Acrylic binder | 10-20% | Emulsion Polymer |
| Water Soluble flurorochemical additive | <5% | Additive/Conditioner/Softener |
| (including, but not limited to, Zonyl ®) | | |
| Polyphase | <1% | |
| a non-ionic high shear viscosity builder | <1% | Viscosity builder |
| (including, but not limited to acrysol) | | |
| Biocide (including, but not limited to | <1% | Biocide/Stabilizer |
| Troysan ®) | | |

The color of the carpet paint is dependent on what pigments and other colorants are added. The method of the present invention may be practiced with any and all colors of the color spectrum. The carpet paint colors are preferably available in all the colors that can be created from the artist's color wheel, black, white, or a combination of these shades and colors. The colors of a standard artist color wheel include red, red-orange, orange, orange-yellow, yellow, yellow-green, green, blue-green, blue, blue-violet, violet, and violet-red. The user will be able to combine these colors, white, and black, to paint carpets in thousands of different resulting colors, color shades, pastels, fluorescents, and other exotic paint colors.

Although the above table details the preferred components of the carpet paint formulation of the present invention, other formulations are possible, so long as the resulting carpet paint may be applied to a carpet to successfully paint the carpet and allow the carpet to retain a similar level of softness, comfort, and texture.

Although the above table details the preferred volume of the components of the final carpet paint, the carpet paint is preferably achieved by mixing 32 parts of a high performance exterior latex paint, 16 parts of an elastomeric acrylic binder, and 1 part of a fluorochemical additive.

Additionally, as will be disclosed in detail below, the carpet paint formulation of the present invention is preferably to be used in conjunction with a fabric softening formula, which is applied to the recently painted carpet.

The method of applying the above described carpet paint formulation to a carpet is now described here in detail.

The method of painting a carpet in the present invention may be practiced with a variety of painting supplies, including paint sprayers, mixers, protective sheets and plastic, tape, hoses, nozzles, tools, a carpet paint color deck or sample cards for the user to chose a color, utility bags, gallons of paint, pH neutralizer, bleach neutralizer, fabric softener, a rake, a brush, an angle corner brush, spray bottles, gloves, a shield and handle, safety glasses, a funnel kit, cloth towels, shoe guards, a carpet display board of samples, a bucket, and cleaning supplies.

Preferably, the first step in painting a carpet is to identify and provide a carpet to be cleaned. Although the method of this invention can be used to paint any carpet, rug, fabric, or upholstery, preferably the carpet is an installed, wall-to-wall carpet. Preferably the person or persons painting the carpet (painters) will bring the paint and supplies to the carpet, rather than removing the carpet and bringing it to the paint and supplies.

The next step in painting a carpet is to clean the carpet. This is typically done professionally. This ensures that the paint will not be applied to dirt or other substances that may interfere with the paint binding and evenly coating the carpet. After the carpet is cleaned, the carpet should be inspected for stains or spots. Any stains or spots identified should be neutralized. The spot and stain inspecting, identifying, and neutralizing procedures are described as follows. There is a difference between a spot and a stain. A spot is a discoloration of material adhered to the outside of a yarn or filament causing a visible spot. It can be removed using a mechanical and/or chemical process. A stain is a discoloration caused by a chemical reaction or by a penetration of dyes, such as dyes, pigments, or bleaches, into the yarn. The majority of spots and stains can be removed with a general cleaning process. Occasionally, however, a spot or stain on a carpet remains that requires special attention. All attempts should be made to remove or neutralize the spot or stain before color spraying the carpet.

The majority of spots found in carpeting can be classified as surface stains, absorbed stains, compound stains or destructive stains. Surface stains form when the staining material is on or between the fibers. For example, grease, gum, or glue may form surface stains. Absorbed stains occur when the staining material is present in the fibers such that penetration of the fibers has taken place. For example, coffee, tea, ink, or urine may cause absorbed stains. Compound stains form when the stains are present on and in the fibers. For example, paint, shoe polish, or lipstick form compound stains. Destructive stains occur when the staining material has altered the nature of the fibers. For example, acids, bleaches, burns, or acne medicines cause destructive stains. As named, most destructive stains cannot be removed and consequently, destructive stains are one of the most difficult types of stains for professional cleaners to treat.

To identify or classify each spot into a category in order to approach it with the right stain removal product, the painter should first determine what was spilled and whether there have been previous attempts to remove the stain. If they have, it is important to know what was used and if there was any reaction on the carpet.

The painter may attempt to identify the stain based on sight, touch, smell, or testing the pH. Based on sight, the shape of the stain will often indicate its origin. A spot with a defined shape will not have occurred from a random spill, but rather may have been transferred by contact from an object such as a mahogany table leg. An irregular pattern would indicate a spill. Spots in a line are caused by dripping from a moving object. The reflective brilliance and color can also help to determine the spot's composition. For example, paint, lacquer, and nail polish are usually shiny. A food spot is usually dull in appearance, reflecting less light. The location of the stain can also be revealing. The user may examine the surrounding area for clues as to the origin of the spot. For example, if there are multiple brown stains near a soda machine, there is a good chance the spot is a beverage spill.

A user may also identify the stain based on touch. For example, certain stains are tacky, waxy, hard, soft, or oily. Also, the smell of the spot can be one of the most accurate, efficient and effective methods of identification, depending on the user's experience and sensitivity to the odor identification. Testing the pH of the stained area can help a user to determine if the discoloration is due to an imbalance of the pH. A user may test a stain's pH with standard pH test strips, by moistening the area with water and blotting the test strip directly on the stain. The strip will change color to indicate the pH level of the area. This color change is then compared to the color chart on the paper dispenser provided by a standard pH test strip kit.

Removing the stain will depend on the classification of the stain. It is often said in chemistry that “like dissolves like.” Water-based stains will be dissolved by a water-based spotter. Solvent/oil-based stains are dissolved by solvent/oil-based spotters. Discoloration can appear on the tips of fibers when the pH of a carpet is elevated or lowered by a spilled substance. In these instances, if the pH is restored to neutral, the discoloration disappears. Some stains require a chemical reaction which neutralizes or chemically changes a stain, thus allowing it to be removed. The introduction of heat to various spotting situations greatly increases the success rate.

After all stains have been treated and neutralized, the next step in painting the carpet is to select the color or colors. As discussed above, the method of the present invention may use one or more paints in thousands of colors. It is important that the color selected by the owner of the carpet is verified by the owner before painting begins. The paint used for this method is preferably the carpet paint that is described in detail above. That is the carpet paint is preferably composed of a base paint, an elastomeric acrylic polymer, and a fluorocarbon additive. The base paint is preferably an acrylic paint composed of a liquid, an acrylic binder, and one or more pigments. The elastomeric acrylic polymer is composed of a liquid and an elastomeric acrylic binder. The fluorocarbon additive is a water soluble fluorocarbon additive that improves the ability to clean a painted carpet of oily dirt and provides oil repellence to the painted carpet. The carpet paint is preferably a combination of 32 parts acrylic base paint, 16 parts elastomeric acrylic polymer, and 1 part additive.

After selection and verification of the carpet paint color, the painter preferably pre-mixes the selected carpet paints. The painter or user typically wears safety equipment such as gloves, goggles, and shoe covers. The user will prepare the area surrounding the carpet to prevent the carpet paint from damaging the room's walls or non-carpeted floors in said area surrounding the carpet. A user may prepare the walls around the carpet and all floors that come in contact with the carpet with tape and plastic or paper.

Although the carpet paint may be applied to the carpet using any mechanism or means, such as a roller or brush, the preferred machine is a paint sprayer. Paint sprayers are well known in the art. The user selects a paint sprayer and then adds paint to the paint sprayer. The paint sprayer is placed next to the carpet, and the tip of the sprayer is pointed towards the carpet. The tip of the sprayer is typically at the end of a spray wand. The user may grip the paint sprayer by the spray handle and point the wand towards the carpet. The spray tip should be placed between 5 centimeters and 60 centimeters from the carpet and preferably the spray tip is placed between 15 centimeters and 25 centimeters from the carpet when ready to begin painting. Before spraying the carpet, the paint sprayer is purged into a bucket, until a consistent color and viscosity is achieved. When spraying the carpet with the paint sprayer, the spraying may begin at a back of the carpet and moves toward a front of the carpet, and the paint sprayer may be moved in a side to side, even, and uniform manner. Alternatively, the paint sprayer may be moved in a back to front, even, and uniform manner. The paint sprayer may apply the paint in any pattern, so long as the portion of carpet to be painted is completely coated.

Typically, the painter will paint a first half, third, fourth, or other portion of the carpet and then stop. Then, the user will brush or rake the carpet paint into the portion of carpet that was painted with a carpet brush or rake. Although the user may use any brushing or raking motion to ensure that the carpet paint thoroughly and completely coats all sides of the fibers of the carpet, the preferred motion is a back to front raking motion. Alternatively, the user may use a side to side, circular or randomly patterned raking motion. The brush or rake may be any applicator that spreads paint onto a surface including, but not limited to, a brush, a rake, a roller, a squeegee, a sponge, a mop, a broom, hands, feet, cloth applicator, such as a towel, a corner or edge painter, or press. The user preferably repeats the spraying and brushing for the other, not yet painted portions of the carpet using the method described immediately above. The user may also repeat these spraying and brushing steps on additional carpets, be they installed or loose pieces. After spraying and brushing, the user should wipe off any excess paint.

Next, the user will prepare a fabric softener solution. The fabric softener solution is preferably 60% water and 40% fabric softener. The user may also add one or more scent solutions to the fabric softener solution while preparing the fabric softener solution. The user should then apply the fabric softener solution to the painted carpet with a pump sprayer. The user will brush the fabric softener solution into the painted carpet with the carpet brush using a back to front raking motion. The same brushed used previously is preferably used again for this brush step.

To finish the method, the user wipes off any excess paint from an overspray, removes protective material from the area surrounding the carpet, and cleans the area surrounding the carpet.

Although the fabric softener is not necessary to achieve a successful painting of a carpet, wherein the carpet retains a soft-to-the-touch texture, the fabric softener solution is preferably added because it better helps the painted carpet retain the tufted softness that is desired. The fabric softener that is used with this method should provide superior softness, better color retention, and enhanced stain protection. The fabric softener may be made from dehydrogenated tallow dimethyl ammonium chloride, polydimethylsiloxane, or any other raw fabric softener base composition.

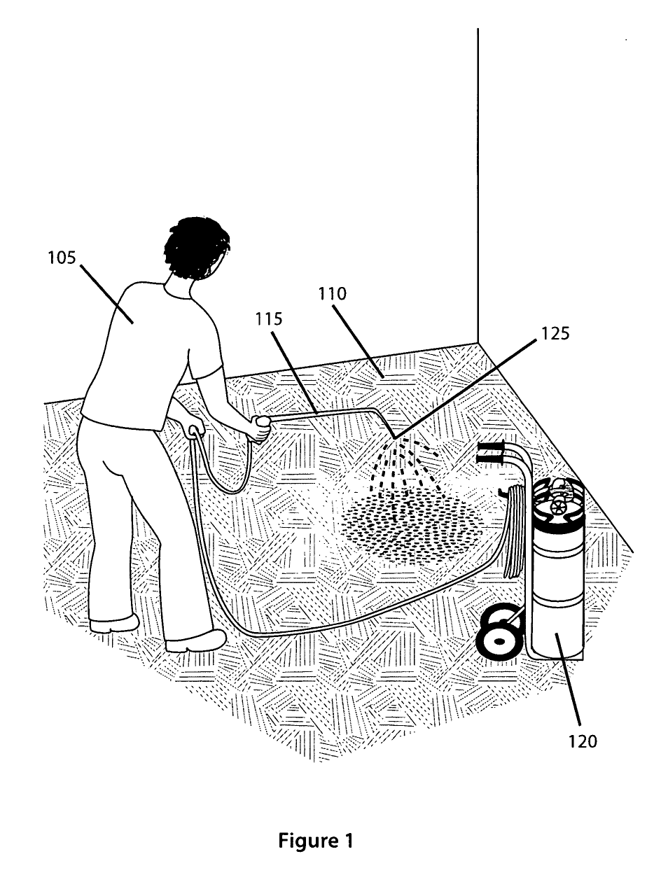

FIG. 1 is an illustration of a user applying to a carpet the claimed paint formulation using a sprayer. FIG. 1 shows a painter 105 using a paint sprayer 120 to spray carpet paint onto carpet 110. The painter moves the paint wand 115 back and forth in an even manner while pointing the tip 125 of the paint spray 120 at the carpet 110. As shown in FIG. 1, the carpet 110 is preferably installed in a wall to wall manner in a room.

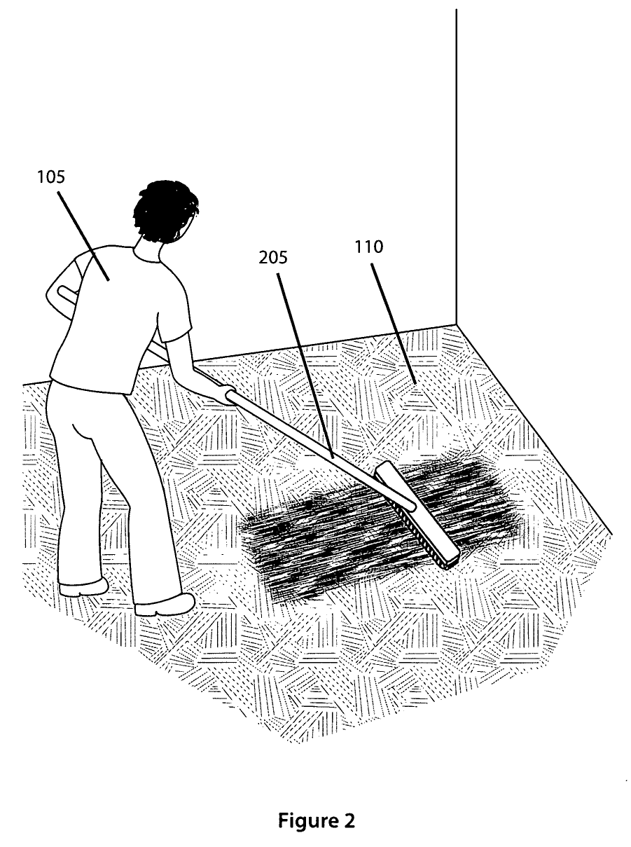

FIG. 2 is an illustration of a user evenly raking paint into a carpet recently sprayed with paint of the claimed paint formulation. FIG. 2 shows a painter 105 using a brush 205 to brush the carpet paint into the recently sprayed carpet 110. This brushing step allows the painter to ensure that the carpet 110 is evenly coated with carpet paint. Alternatively, FIG. 2 is also illustrative of a painter brushing in the fabric softener solution with a brush 205.

In summary, the present invention is a formulation for carpet paint, and a method for applying the same to a carpet using the techniques disclosed herein.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Nothing that has been stated or illustrated is intended or should be interpreted to cause a dedication of any component, step, feature, object, benefit, advantage, or equivalent to the public, regardless of whether it is recited in the claims.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

What is claimed is:

1. A carpet paint, comprising:
a base paint;
an elastomeric acrylic polymer; and
a fluorocarbon additive.

2. The carpet paint of claim 1, wherein said base paint is an acrylic paint and is comprised of, a liquid, an acrylic binder, and one or more pigments;
wherein said elastomeric acrylic polymer is comprised of, said liquid, an elastomeric acrylic binder; and
wherein said fluorocarbon additive is a water soluble fluorocarbon additive that improves the ability to clean a painted carpet of oily dirt and provides oil repellence to said painted carpet.

3. The carpet paint of claim 2, wherein said liquid is a water; and
wherein said carpet paint is essentially thirty-two parts said acrylic paint, sixteen parts said elastomeric acrylic polymer, and one part said fluorocarbon additive.

4. The carpet paint of claim 3, wherein said carpet paint is used to coat and color a carpet.

5. The carpet paint of claim 4, wherein said carpet is permanently attached to a floor; and
wherein said carpet is colored without removing said carpet from said floor.

6. The carpet paint of claim 5, further comprising:
one or more components selected from the group consisting of, a sanitizing agent, a fungicide, a biocide, a pesticide, an algaecide, a mildewcide, a boric acid, a pet enzyme, a deodorizer, a florescent, or a scent.

7. The carpet paint of claim 6, further comprising:
a water-soluble cellulose ether; a propylene glycol; a pigment dispersant; a low foam surfactant; an ester alcohol; a foam control agent; a thickening agent; a thixotropic thickening agent; an ammonia; and a non-ionic high shear viscosity builder.

8. The carpet paint of claim 7, wherein said acrylic paint is selected from the group consisting of, a flat paint, a satin paint, a gloss paint, a metallic paint, a multicolored paint, a glow in the dark paint, a florescent paint, a glitter paint, a primer paint, or a multi-tone paint.

9. A method for painting carpet, the steps comprising:
providing a carpet;
providing a carpet paint, wherein said carpet paint is comprised of a base paint, an elastomeric acrylic polymer, and a fluorocarbon additive;
applying said carpet paint to said carpet; wherein said carpet paint is applied in an even manner to said carpet.

10. The method for painting carpet of claim 9, the steps further comprising: applying a fabric softener solution to said painted carpet.

11. A method for painting carpet, the steps comprising:
providing a carpet;
providing one or more carpet paints; wherein said one or more carpet paints are comprised of a base paint, an elastomeric acrylic polymer, and a fluorocarbon additive; wherein said one or more carpet paints are in a plurality of colors;
selecting one or more of said plurality of paint colors to apply to said carpet;
pre-mixing said one or more carpet paints;
adding at least one of said one or more carpet paints to a paint sprayer;
purging said paint sprayer, wherein said paint sprayer is purged until a consistent color and viscosity is achieved;
placing a tip of said paint sprayer towards the carpet;
spraying said carpet with said paint spray;
brushing said one or more carpet paints into said carpet;

12. The method for painting a carpet of claim 11, the steps further comprising:
preparing a fabric softener solution, wherein fabric softener solution is 60% water and 40% fabric softener;
applying said fabric softener solution to said painted carpet with a pump sprayer; and
brushing said fabric softener solution into said painted carpet.

13. The method for painting a carpet of claim 12, wherein said base paint is an acrylic paint and is comprised of, a liquid, an acrylic binder, and one or more pigments; wherein said elastomeric acrylic polymer is comprised of, said liquid, an elastomeric acrylic binder; and wherein said fluorocarbon additive is a water soluble fluorocarbon additive that improves the ability to clean a painted carpet of oily dirt and provides oil repellence to said painted carpet.

14. The method for painting a carpet of claim 13, wherein said carpet is permanently affixed to a floor of a structure, and wherein said carpet is painted as permanently affixed to said floor.

15. The method for painting a carpet of claim 14, the steps further comprising:
adding one or more scent solutions to said fabric softener solution during said preparing of said fabric softener solution step.

16. The method for painting a carpet of claim 15, the steps further comprising:
cleaning said carpet before painting said carpet;
inspecting said carpet for stains;
identifying stains on said carpet;
neutralizing stains on said carpet;

17. The method for painting a carpet of claim 16, the steps further comprising:
preparing an area surrounding said carpet with a protective material before painting said carpet;
wherein said preparing step prevents said carpet paint from damaging one or more walls and one or more non-carpeted floors in said area surrounding said carpet;
wiping off an excess paint from said carpet due to an overspray after painting said carpet;
removing said protective material from said area surrounding said carpet; and
cleaning said area surrounding said carpet.

18. The method for painting a carpet of claim 17, the steps further comprising:
stopping said spraying step when a first portion of one or more portions of said carpet is completed;
completing said brushing step on said first portion of said carpet;
repeating said spraying step and said brushing step for one or more not yet painted portions of said carpet;

19. The method for painting a carpet of claim 18, the steps further comprising:
repeating said spraying and brushing steps on one or more additional carpets in one or more additional rooms of said structure;

20. The method for painting a carpet of claim 19, wherein said spray tip is placed between 15 centimeters and 25 centimeters from said carpet.
